(19) United States
(12) Patent Application Publication
(10) Pub. No.: US 2011/0055521 A1
(43) Pub. Date: Mar. 3, 2011

(54) MICROPROCESSOR HAVING AT LEAST ONE APPLICATION SPECIFIC FUNCTIONAL UNIT AND METHOD TO DESIGN SAME

(75) Inventors: Laura Pozzi, Lugano (CH); Paolo Ienne Lopez, Pully (CH)

(73) Assignee: ECOLE POLYTECHNIQUE FEDERALE DE LAUSANNE (EPFL), Lusanne (CH)

(21) Appl. No.: 12/311,177

(22) PCT Filed: Sep. 24, 2007
(86) PCT No.: PCT/IB2007/053866

§ 371 Date: Apr. 5, 2010

Related U.S. Application Data
(60) Provisional application No. 60/846,353, filed on Sep. 22, 2006.

(51) Int. Cl. G06F 9/30

(52) U.S. Cl. 712/200; 712/E09.023

(57) ABSTRACT

Customisable embedded processors that are available on the market make it possible for designers to speed up execution of applications by using Application-specific Functional Units (AFUs), implementing Instruction-Set Extensions (ISEs). Furthermore, techniques for automatic ISE identification have been improving; many algorithms have been proposed for choosing, given the application's source code, the best ISEs under various constraints. Read and write ports between the AFUs and the processor register file are an expensive asset, fixed in the micro-architecture—some processors indeed only allow two read ports and one write port—and yet, on the other hand, a large availability of inputs and outputs to and from the AFUs exposes high speedup. Here we present a solution to the limitation of actual register file ports by serialising register file access and therefore addressing multi-cycle read and write. It does so in an innovative way for two reasons: (1) it exploits and brings forward the progress in ISE identification under constraint, and (2) it combines register file access serialisation with pipelining in order to obtain the best global solution. Our method consists of scheduling graphs—corresponding to ISEs—under input/output constraint

### FIELD OF THE INVENTION

Customisable Processors represent an emerging and effective paradigm for executing embedded application under high performance, short time to market, and low power requirements. Among the possible customisation directions, a particularly interesting one is that of Instruction-Set Extensions (ISE): Application-specific Functional Units (AFUs) can be added to the processor core in order to speed up a particular application and implement specialised instructions. As these processors become available—e.g., Tensilica Xtensa, ARC ARCtangent, STMicroelectronics ST200, and MIPS CorExtend—techniques are emerging for automatically selecting the best ISEs for an application, given the application source code and under various constraints.

An example of such technique is described in the document US 2007/0162902.

### BRIEF DESCRIPTION OF THE INVENTION

Customisable embedded processors that are available on the market make it possible for designers to speed up execution of applications by using Application-specific Functional Units (AFUs), implementing Instruction-Set Extensions (ISEs). Furthermore, techniques for automatic ISE identification have been improving; many algorithms have been proposed for choosing, given the application's source code, the best ISEs under various constraints. Read and write ports between the AFUs and the processor register file are an expensive asset, fixed in the micro-architecture—some processors indeed only allow two read ports and one write port—and yet, on the other hand, a large availability of inputs and outputs to and from the AFUs exposes high speedup. Here we present a solution to the limitation of actual register file ports by serialising register file access and therefore addressing multi-cycle read and write. It does so in an innovative way for two reasons: (1) it exploits and brings forward the progress in ISE identification under constraint, and (2) it combines register file access serialisation with pipelining in order to obtain the best global solution. Our method consists of scheduling graphs—corresponding to ISEs—under input/output constraint

In the present application, the optimization of microprocessor is achieved with a microprocessor having at least one Application specific Functional Unit (AFU), said AFU implements a part of the functionality of an Instruction Set Extension (ISE), said ISE corresponds to a data flow graph having a plurality of inputs and outputs, said microprocessor having micro-architectural constraints including, but not restricted to: number of register file read ports, number of register file write ports and cycle time, said AFU comprising a set of storage elements and at least one new architectural microprocessor op-code for each ISE.

### BRIEF DESCRIPTION OF THE DRAWINGS

The invention will be better understood thanks to the attached drawings in which:

the FIG. 1 illustrates ISE performance on the des cryptography algorithm, as a function of the I/O constraint.

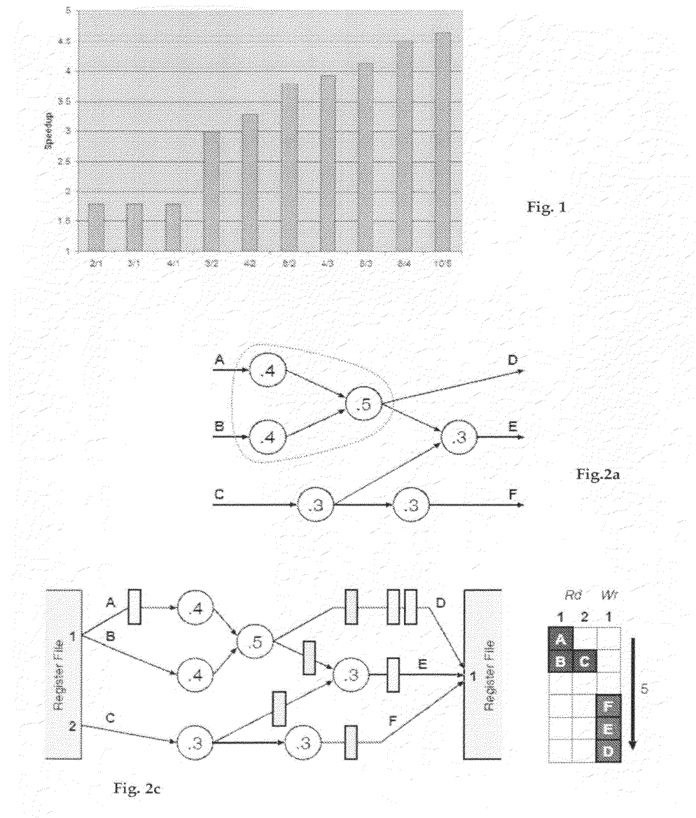

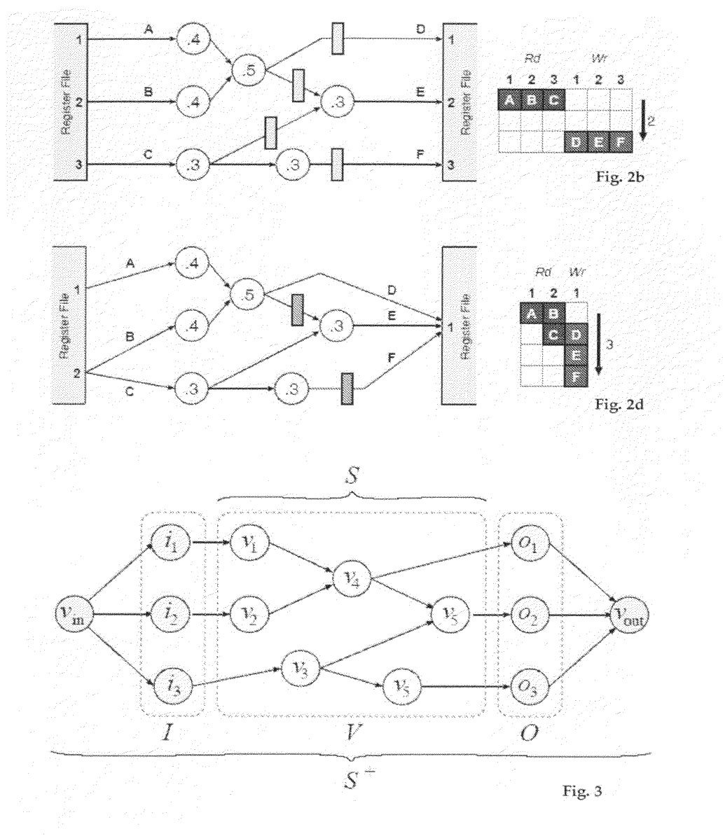

the FIG. 2 illustrates four examples:
(2a) The DAG of a basic block annotated with the delay in hardware of the various operators.
(2b) A possible connection of the pipelined datapath to a register file with 3 read ports and 3 write ports (latency=2).
(2c) A naive modification of the datapath to read operands and write results back through 2 read ports and 1 write port, resulting in a latency of 5 cycles.
(2d) An optimal implementation for 2 read ports and 1 write port, resulting in a latency of 3 cycles. Rectangles on the DAG edges represent pipeline registers. All implementations are shown with their I/O schedule on the right.

the FIG. 3 illustrates a sample augmented cut S+.

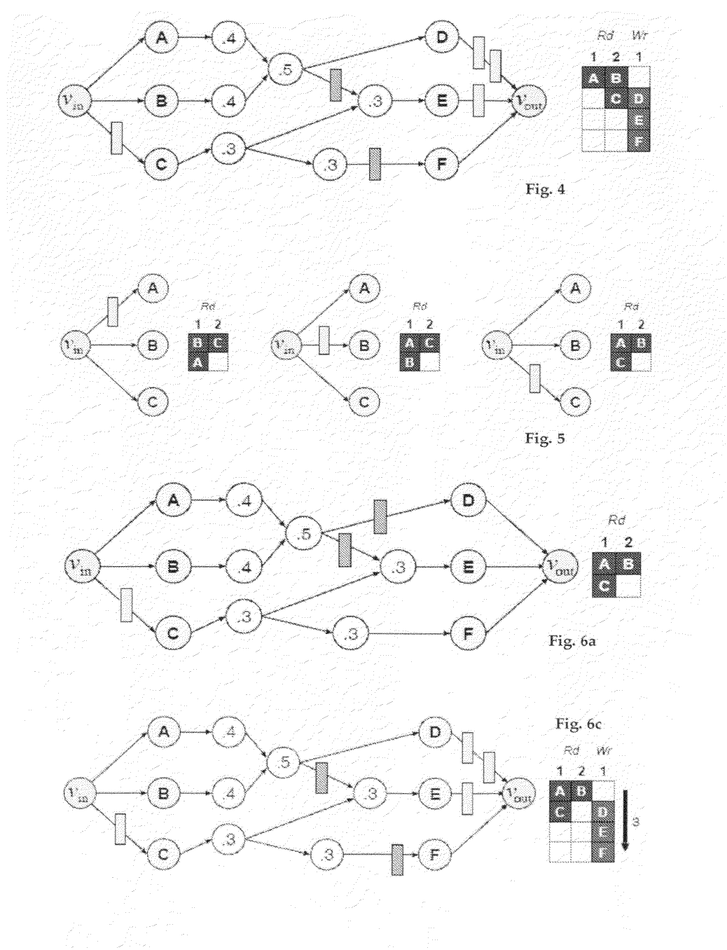

the FIG. 4 illustrates the graph S+ of the optimised implementation shown in FIG. 2(d). All constraints of Problem 1 are verified and the number of pipeline stages R is minimal.

the FIG. 5 illustrates all possible input configurations for the motivational example, obtained by repeatedly applying an n choose r pass to the input nodes.

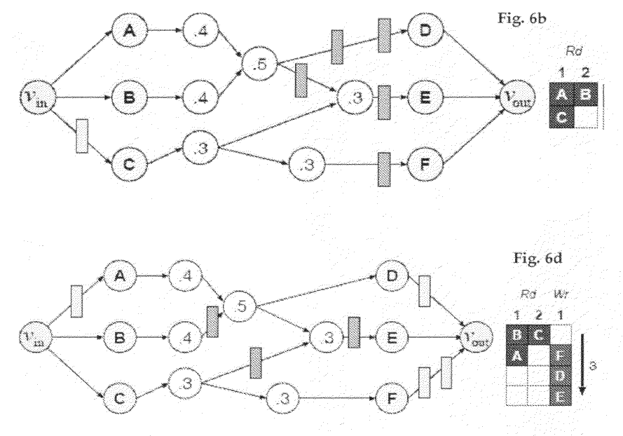

the FIG. 6 illustrates the proposed algorithm.
(6a) The scheduling pass of FIG. 6 is applied to the graph, for the third initial configuration of FIG. 5. The schedule is legal at the inputs but not at the outputs. (6b) One line of registers is added at the outputs.
(6c) Three registers at the outputs are transformed into pseudoregisters, in order to satisfy the output constraint.
(6d) The final schedule for another input configuration. Its latency is also equal to three, but three registers are needed; this configuration is therefore discarded.

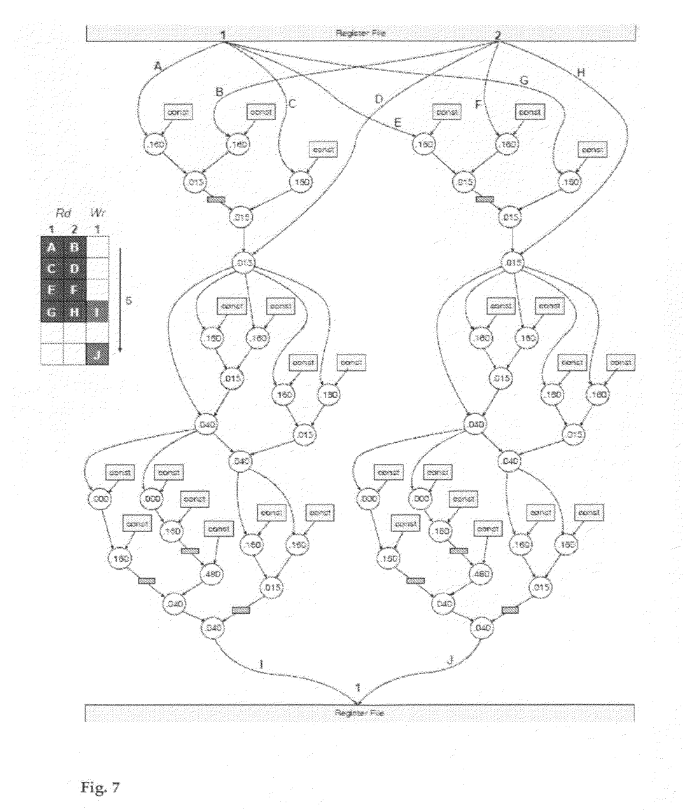

the FIG. 7 illustrates sample pipelining for a 8/2 cut from the aes cryptography algorithm with an actual constraint of 2/1. Compared to a naive solution, this circuit saves eleven registers and shortens the latency by a few cycles.

### DETAILED DESCRIPTION

A particularly expensive asset of the processor core is the number of ports to the register file that the AFUs are allowed to use. While this number is typically kept small in available processors—indeed some only allow two read ports and one write port—it is also true that input/output allowance impacts directly on speedup. A typical trend can be seen in FIG. 1, where the speedup for various combinations of I/O constraints is shown, for an application implementing the DES cryptography algorithm. On a typical embedded application, the I/O constraint impacts strongly on the potentiality of ISE: speedup goes from 1.7 for 2 read and 1 write ports, to 4.5 for 10 read and 5 write ports. Intuitively, if the I/O allowance increases, larger portions of the application can be mapped onto an AFU, and therefore a larger part can be accelerated.

As a motivational example, consider FIG. 2(a), representing the Direct Acyclic Graph (DAG) of a basic block. Assume that each operation occupies the execution stage of the processor pipeline for one cycle when executed in software. In hardware, the delay in cycles (or fraction thereof) of each operator is shown inside each node. Under an I/O constraint of 2/1, the sub-graph indicated with a dashed line on FIG. 2(a) is the best candidate for ISE. Its latency is one cycle (ceiling of the sub-graph's critical path), while the time to execute the sub-graph on the unextended processor is roughly 3 cycles (one per operation). Two cycles are therefore saved every time the ISE is used instead of executing the corresponding sequence of instructions. Under an I/O constraint of 3/3, on the other hand, the whole DAG can be chosen as an AFU (its latency in hardware is 2 cycles, its software latency is approximately 6 cycles, and hence 4 cycles are saved at each invocation). FIG. 2(b) shows a possible way to pipeline the complete basic block into an AFU, but this is exclusively possible if the register file has 3 read and 3 write ports. If the I/O constraint is 2/1, a common solution is to implement the smaller sub-graph instead and reduce significantly the potential speedup.

We present a method that identifies ISE candidates that exceed the constraint, and then map them on the available I/O by serialising register port access. FIG. 2(c) shows a naive way to realise serialisation, which simply (i) maintains the position of pipelines registers as it was in FIG. 2(b) and (ii) adds registers at the beginning and at the end to account for serialised access. As indicated in the I/O access table, value A is read from the register file in a first cycle, then values B and C are read and execution starts. Finally, two cycles later, the results are written back in series into the register file, in the predefined (and naive) order of F, E and D. The schedule is legal since only at most 2 read and/or 1 write happen simultaneously. Latency, calculated from the first read to the last write, is now 5 cycles: only 1 cycle is saved. However, a better schedule for the DAG can be constructed by changing the position of the original pipeline registers, in order to allow that register file access and computation can proceed in parallel. FIG. 2(d) shows the best legal schedule, resulting in a latency of 3 cycles and hence a gain of 3 cycles: searching for larger AFU candidates and then pipelining them in an efficient way, in order to serialise register file access and to ensure I/O legality, can be beneficial and can boost the performance of ISE identification.

Presented is a method for identifying an ISE that recognises the possibility of serialising operand-reading and result-writing of AFUs that exceed the processor I/O constraints. It also presents a method for input/output constrained scheduling that minimises the resulting latency and the number of storage elements for the given latency, of the chosen AFUs by combining pipelining with multi-cycle register file access. Measurements of the obtained speedup show that the proposed method finds high-performance schedules resulting in tangible improvement when compared to the single-cycle register file access case.

Related Work

Discussion of the state of the art is here divided in two parts: the first relates to scheduling and pipelining, while the second details works on automatic Instruction-Set Extension.

A well known unconstrained scheduling for minimum latency is ASAP, while many scheduling algorithms under constraint have been presented, such as resource-constrained and time-constrained. Resource-constrained scheduling limits the number of computational resources that can be used in a cycle; it is an intractable problem, and list scheduling is a heuristic used for solving it. Proposed solutions to time-constrained scheduling, where relative timing constraints between operations are specified, include Force Directed Scheduling and integer linear programming. This paper defines and solves another type of constrained scheduling, called here constrained scheduling, which finds the minimum latency schedule for a DAG under the constraint that no more than Nᵢₙ inputs and no more than Nₒᵤₜ outputs can be read and written in any given cycle. It can be seen as a special case of resource-constrained scheduling. Retiming algorithms are also related to this work, where registers are moved in a circuit in order to optimise performance or area. In particular, a reported algorithm for retiming DAGs is similar to a step of the I/O constrained scheduling algorithm presented here.

The problem of identifying instruction-set extensions consists in detecting clusters of operations which, when implemented as a single complex instruction, maximise some metric—typically performance. Such clusters must invariably satisfy some constraint; for instance, they must produce a single result or use no more than four input values. The problem solved by the algorithms presented in this paper is formalised in Section III, but this generic formulation is used here to discuss related work.

Some methods have been proposed where authors essentially concentrate on targeting maximal reuse of complex instructions. In this case, sequences or simple clusters of operations often appear as the best candidates. The importance of growing larger clusters for high speedup is acknowledged in some recent works. Another recent formulation, experimented on the Nios II processor, uses an exponential enumeration algorithm to find all patterns with a single output; the algorithm is usable in practice in the given micro-architectural context by limiting the number of inputs.

Work on Application Specific Instruction-set Processors (ASIPs) generation is also related to ISE identification, but it differs from the latter because it involves generation of complete instruction sets for specific applications.

The present work combines any ISE identification algorithm that works under constraint with AFU pipelining and I/O constrained scheduling. It recognises the possibility of serialising access to the register file and identifies AFUs with larger I/O constraint than the allowed microarchitectural one; then, it automatically maps them to the actual read/write port availability. To the best of our knowledge, this is the first work that proposes a solution to exploit this possibility in an automatic way.

ISE Selection

Our method is similar in nature to the single-cut identification problem addressed in prior work: we want to find a convex sub-graph S of the Data Flow Graph (DFG) of a basic block. The sub-graph S, which we call cut, represents the functionality to be implemented in a specialised functional unit. The cut S therefore maximises some merit function M(S), which represents the speedup achieved when the cut is implemented as a custom instruction, while input and output nodes of S are such as to allow implementation with a limited number of register-file ports—that is, IN (S)≧Nᵢₙ and OUT(S)≦Nₒᵤₜ, where the constants Nᵢₙ and Nₒᵤₜ depend from the micro-architecture. Finally, S must be a convex graph to guarantee schedulability in typical compilers.

However our method differs from the above problem (disclosed in US2007/0162902) for the following two reasons: (a) the cut S is allowed to have more inputs than the read ports of the register file and/or more outputs than the write ports; if this happens, (b) successive transfers of operands and results to and from the specialised functional unit are accounted for in the latency of the special, instruction. Our method considers (b) while at the same time it introduces pipeline registers, if needed, in the data-path of the unit.

The way we solve the new single-cut identification problem consists of three steps: (1) Best cuts for an application using any ISE identification algorithm (e.g., the single-cut identification described in US2007/0162902) are generated for all possible combinations of input and output counts equal and above Nᵢₙ and Nₒᵤₜ, and below a reasonable upper bound, e.g., 10/5. (2) Both the registers required to pipeline the functional unit under a fixed timing constraint (the cycle time of the host processor) and the registers to store temporarily excess operands and results are added to the DFG of S. In other words, the actual number of inputs and outputs of S are made to fit the micro-architectural constraints. (3) We select the best ones among all cuts. Step (2) is the actual problem that is formalised and solved using the method described here.

Problem Statement

We call S(V, E) the DAG representing the dataflow of a potential special instruction to be implemented in hardware; the nodes V represent primitive operations and the edges E represent data dependencies. Each graph S is associated to a graph

S⁺(V∪I∪O∪{vᵢₙ, vₒᵤₜ}, E∪E⁺)
which contains additional nodes I, O, vᵢₙ, and vₒᵤₜ, and edges E⁺. The additional nodes I and O represent, respectively, input and output variables of the cut. The node vᵢₙ is called source and has edges to all nodes in I. Similarly, the node vₒᵤₜ is the sink and all nodes in O have an edge to it. The additional edges E⁺ connect the source to the nodes I, the nodes I to V, V to O, and O to the sink. FIG. 3 shows an example of cut.

Each node uεV has associated a positive real weight, λ(u); it represents the latency of the component implementing the corresponding operator. Nodes vᵢₙ, vₒᵤₜ, I, and O have a null weight. Each edge (u,v)εE has an associated positive integer weight, ρ(u,v); it represents the number of registers in series present between the adjacent operators. A null weight on an edge indicates a direct connection (i.e., a wire). Initially all edge weights are null (that is, the cut S is a purely combinatorial circuit).

Our goal is to modify the weights of the edges of S⁺ in such a way as to have (1) the critical path (maximal latency between inputs and registers, registers and registers, and registers and outputs) below or equal to some desired value Λ, (2) the number of inputs (outputs) to be provided (received) at each cycle below or equal to Niₙ (Nₒᵤₜ), (3) a minimal number of pipeline stages, R. To express this formally, we introduce the sets W^{I N} which contain all edges (viₙ,u) whose weight ρ(viₙ,u) is equal to i. Similarly the sets Wi^{OUT} contain all edges (u, vₒᵤt) whose weight ρ(u, vₒᵤt) is equal to i. We write Wᵢ^{IN} to indicate the number of elements in the set W^{IN}. The problem we want to solve is the particular case of scheduling described below.

Problem 1: Minimise R under the following constraints:

1) Pipelining. For all combinatorial paths between uεS⁺ and vεS⁺—that is, for all those paths such that: Σ_{all edge (s,t) on the path}ρ(s,t)=0;

$${\sum }_{all nodes k on the patch} λ ( κ ) \leq Λ \qquad ( 1 )$$

2) Legality. For all paths between vᵢₙ and vₒᵤₜ,

$${\sum }_{all edge ( u , v ) on the patch} ρ ( u , v ) = R - 1 \qquad ( 2 )$$

3) I/O schedulability ∀i≧0

|Wᵢ^{IN}|≦Nin and |Wᵢ^{OUT}|≦N_{OUT} (3)

The first bullet ensures that the circuit can operate at the given cycle time Λ. The second ensures a legal schedule, that is, a schedule which guarantees that the operands of any given instruction arrive together. The third bullet defines a schedule of communication to and from the functional unit that never exceeds the available register ports: for each edge (vᵢₙ,u), registers ρ(vᵢₙ,u) do not represent physical registers, but the schedule used by the processor decoder to access the register file. Similarly, for each (u, vₒᵤt), ρ(u, vₒᵤt) indicates when results are to be written back. For this reason, registers on input edges (viₙ, u) and on output edges (u, vₒᵤₜ) will be called pseudo-registers from now on; in all figures, they are shown with a lighter colour than physical registers. As an example, FIG. 4 shows the graph S⁺ of the optimised implementation shown in FIG. 2(d) with the pseudo-registers which express the register file access schedule for reading and writing. Note that the graph satisfies the legality check expressed above: exactly two registers are present on any given path between vᵢₙ and vₒᵤₜ.

Method

The method proposed for solving Problem 1 first generates all possible pseudo-registers configurations at the inputs, meaning that pseudo-registers are added on input edges (vᵢₙ,u) in all ways that satisfy the input schedulability constraint, i.e., |Wᵢ^{IN}|≦Nᵢₙ. This is obtained by repeatedly applying the n choose r problem—or r combinations of an n set—with r=Nᵢₙ and n=|I|, to the set of input nodes I of S⁺, until all input variables have been assigned a read-slot—i.e., until all input edges (vᵢₙ, u) have been assigned a weight ρ(vᵢₙ,u). Considering only the r combinations ensures that no more than Nᵢₙ input values are read at the same time. The number of n choose r combinations is

$$( \begin{matrix}n \\ r\end{matrix} ) = \frac{n !}{r ! ( n - r ) !} .$$

By repeatedly applying n choose r until all inputs have been assigned, the number of total configurations becomes

$$\frac{n !}{{( r ! )}^{X} {( n - xr ) !}^{′}} , with x = [ \frac{n}{r} ] - 1.$$

Note that the complexity of this step is exponential in the number of inputs of the graph, which is a very limited quantity in practical cases (e.g., in the order of tens). FIG. 5 shows the possible configurations for the simple example of FIG. 2: I=A, B, C and the configurations, as defined above, are AB->C, AC->B and BC->A. Note that the above definition does not include, for example, A->BC. In fact, since we are scheduling for minimum latency, as many inputs as possible are read every time.

Then, for every input configuration, the algorithm proceeds in 3 steps:

(1) A scheduling pass, described in the pseudocode below, is applied to the graph, visiting nodes in topological order. The algorithm essentially computes an ASAP schedule, but it differs from a general ASAP version because it considers an initial pseudoregister configuration. It is an adaptation of a retiming algorithm for DAGs and its complexity is O(|V|+|E|). FIG. 6(a) shows the result of applying the scheduling algorithm to one of the configurations.

(2) The schedule is now legal at the inputs but not necessarily at the outputs, and some registers might have to be added. The schedule is legal at the output only if at most Nₒᵤₜ edges to output nodes have 0 registers (i.e., a weight equal to zero), at most Nₒᵤₜ edges to output nodes have a weight equal to 1, and so on. If this is not the case, a line of registers on all output edges is added until the previously mentioned condition is satisfied. FIG. 6(b) shows the result of this simple step.

(3) Registers at the outputs are transformed into pseudo-registers (i.e., they are moved to the right of output nodes, on edges (u, vₒᵤₜ)), as shown in FIG. 6(c). The schedule is now legal at both inputs and outputs.

All schedules of minimum latency are the ones that solve Problem 1. Among them, a schedule requiring a minimum number of registers is then chosen. FIG. 6(d) shows the final schedule for another input configuration which has the same latency but a larger number of registers (3 vs. 2) than the one of FIG. 6(c).

Example of pseudocode of the ASAP algorithm. For every node u, path delay(u) indicates the maximum delay among paths to the node that have no registers, and delay(u) indicates its individual delay, λ. For every edge e, path weight(e) indicates the maximum number of registers from the source node vin to the edge, and weight(e) indicates the number of registers on the edge itself, ρ.

```
// path_weight for edges (vᵢₙ, u) set to input configuration
// path_weight for other edges initialised to 0
// path_delay initialised to 0
forall_nodes(u ε V ∪ I ∪ O ∪ {vₒᵤₜ}) {
  max_pw = max (path_weight of all in_edges of u);
  max_CP_delay = max (CP_delay of all in_edges with max_pw);
  if((max_CP_delay + delay(u) > Λ) {
    additional_reg = 1;
    CP_delay(u) = delay(u);
  } else {
    additional_reg = 0;
    CP_delay(u) = max_CP_delay + delay(u);
  }
  tot_pw = max_pw + additional_reg;
  forall_in_edges(in_e, u)
    weight(in_e) = tot_pw − path_weight(in_e);
  forall_out_edges (out_e, u)
    path_weight(out_e) = tot_pw);
}
```

FIG. 7 shows an example of 8/2 cut which has been pipelined and whose inputs and outputs have been appropriately sequentialised to match an actual 2/1 constraint. The example has an overall latency of five cycles and contains only eight registers (and six of them are essential for correct pipelining). With the naive solution illustrated in FIG. 2(c), twelve registers (one each for C and D, two each for E and F, etc.) would have been necessary to resynchronise sequentialised inputs (functionally replaced here by the two registers close to the top of the cut) and one additional register would have been needed to delay one of the two outputs: our algorithm makes good use of the data independence of the two parts of the cut and reduces both hardware cost and latency. This example also suggests some ideas for further optimizations: if the symmetry of the cut had been identified, the right and left datapath could have been merged and the single datapath could have been used successively for the two halves of the cut. This would have produced the exact same schedule at an approximately half hardware cost, but the issues involved in finding this solution go beyond the scope of this paper.

1. A microprocessor having at least one Application specific Functional Unit (AFU), said AFU implements a part of the functionality of an Instruction Set Extension (ISE), said ISE corresponds to a data flow graph having a plurality of inputs and outputs, said microprocessor having micro-architectural constraints including, but not restricted to: number of register file read ports, number of register file write ports and cycle time, said AFU comprising a set of storage elements and at least one new architectural microprocessor op-code for each ISE.

2. The microprocessor of claim 1, wherein:
the ISE has, either more inputs than the number of register file read ports or more outputs than the number of register file write ports; or has more inputs than the number of register file read ports and more outputs than the number of register file write ports.

3. The microprocessor of claim 1, wherein:
the number of inputs of an AFU is at most equal to the number of register file read ports.

4. The microprocessor of claim 1, wherein:
the number of outputs of an AFU is at most equal to the number of register file write ports.

5. The microprocessor of claim 1, wherein:
each AFU is realised as an op-code of the microprocessor architecture.

6. The microprocessor of claim 1, wherein:
each AFU is realised as an op-code of the microprocessor architecture.

7. The microprocessor of claim 1, wherein:
the maximum delay is the maximum time that can elapse from when an AFU receives its inputs to when the AFU must produce its outputs and is less or equal to the cycle time.

8. The microprocessor of claim 1, wherein:
each storage element can have either a predefined number of bits or have at least as many bits that is necessary to represent the largest value the register must hold.

9. The microprocessor of claim 1, wherein:
a storage element can be realised as one of, but not restricted to: register that is architecturally visible; a register that is architecturally invisible; or a memory distinct from the main memory hierarchy.

10. The microprocessor of claim 1, wherein each ISE corresponds to a set of AFUs:
each AFU corresponds to a sub-graph of the ISE, the set of AFU sub-graphs is a partition of the ISE, and the union of all such sub-graphs is equal to the ISE and the intersection of all such sub-graphs is the empty set.

11. The microprocessor of claim 10, wherein:
each AFU implements the functionality of its corresponding sub-graph.

12. The microprocessor of claim 10 wherein:
for each edge of the ISE connecting different AFU sub-graphs, exists a storage element corresponding to that edge.

13. The microprocessor of claim 10, wherein the number of AFUs in the set is minimal.

14. The microprocessor of claim 10, wherein the set of AFUs comprises a minimal number of storage elements.

15. Method to design at least one Application specific Functional Unit (AFU) connected to a microprocessor CPU, said AFU implements a part of the functionality of an Instruction Set Extension (ISE) wherein an ISE corresponds to a data flow graph having a plurality of inputs and outputs, said microprocessor having architectural and micro-architectural constraints including, but not restricted to: number of register file read ports, number of register file write ports and cycle time, this method comprising the steps of:
receiving at least one instruction set extension (ISE), a set of architectural and micro-architectural constraints,
generating automatically at least one application specific functional unit (AFU), a set of storage elements and at least one new architectural op-code for each ISE, said AFU having more inputs and outputs than the register file read and write ports, thanks to optimal pipelining and optimal use of storage elements.

16. Method to design at least one Application specific Functional Unit (AFU) of claim 15, said AFU being targeted to a specific hardware technology, in which the ISE has more than the number of N input operands or P output operands provided by the register file of the microprocessor, this method comprising the steps of:
Assigning to each basic operation of said ISE a delay based on the targeted hardware technology and the input operands,
Assuming a particular ISE with Q inputs and R outputs (Q>N and/or R>P).
Considering said ISE as a Directed Acyclical Graph (DAG), whose nodes are basic operations, and the edges are data paths.
Building the set of all possible combinations of the Q inputs under the constraint of reading only N inputs in one cycle, by adding one or more pseudoregisters to take into account the fact that the resulting value will be available at a later cycle, for each combination above, performing the following steps to produce a legal schedule:
1) Applying a scheduling pass to compute an ASAP (As Soon As Possible) schedule, taking the initial pseudoregisters into account, therefore following all paths from each node and inserting a pipeline register once the sum of delays along the path reaches the time of a cycle.
2) Determining legal output status by checking the condition whether at most P connections (edges of the graph) to output nodes have 0 registers, at most P edges to output nodes have 1 register, and so on, in the negative event, adding a line of registers on all output edges and rechecking the condition above until the condition is satisfied.
3) Transforming the output registers into pseudoregisters
Of all the legal schedules produced above, selecting the schedule with minimal latency, and then with the minimum number of added registers.
